(19) United States
(12) Patent Application Publication
(10) Pub. No.: US 2005/0177371 A1
(43) Pub. Date: Aug. 11, 2005

(54) Automated speech recognition

(76) Inventors: Sherif Yacoub, Mountain View, CA (US); Steven J. Simske, Fort Collins, CO (US); Xiaofan Lin, San Jose, CA (US); R. John Burns, Half Moon Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/773,392

(22) Filed: Feb. 6, 2004

(51) Int. Cl. G06F 17/00

(52) U.S. Cl. 704/270.1

(57) ABSTRACT

A system comprises a first speech recognition engine, a second speech recognition engine, and evaluation logic coupled to the first and second speech recognition engines. The evaluation logic evaluates the first and second speech recognition engines based on evaluation voice signals from a user and, based on the evaluation, selects one of said speech recognition engines to process additional speech signals from the user.

### BACKGROUND

Some computer systems may be adapted to detect and recognize spoken words. Typically, an input device, such as a microphone or a telephone, receives the spoken words and converts the words into an analog or digital computer readable representation. An automated speech recognition (ASR) engine may utilize the representation to detect and recognize the words.

In many situations, the ASR engine may be licensed to an organization from an external developer of the engine. The license may specify the maximum number of simultaneous connections allowed to be established with the ASR engine. Unfortunately, the number of connections needed may exceed the number of connections allowed by the license. In addition, modifying the license to increase the number of allowable connections may result in a fee imposed by the developer.

### BRIEF SUMMARY

In accordance with at least some embodiments, a system comprises a first speech recognition engine, a second speech recognition engine, and evaluation logic coupled to the first and second speech recognition engines. The evaluation logic evaluates the first and second speech recognition engines based on evaluation voice signals from a user and, based on the evaluation, selects one of said speech recognition engines to process additional speech signals from the user.

### BRIEF DESCRIPTION OF THE DRAWINGS

For a detailed description of exemplary embodiments of the invention, reference will now be made to the accompanying drawings in which:

FIG. 1 shows a system constructed in accordance with embodiments of the invention and including a speech recognition module;

FIG. 2 shows a block diagram of the speech recognition module of FIG. 1; and

FIG. 3 illustrates a flow chart of an exemplary connection procedure in accordance with embodiments of the invention.

### NOTATION AND NOMENCLATURE

Certain terms are used throughout the following description and claims to refer to particular system components. As one skilled in the art will appreciate, various companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

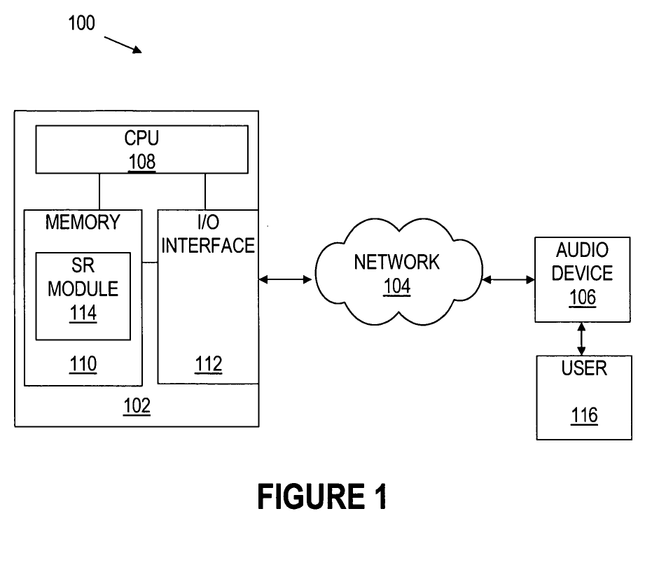

FIG. 1 shows an automated speech recognition (ASR) system 100 configured in accordance with embodiments of the invention. As shown, system 100 comprises a computer system 102, a network 104, and one or more audio devices 106. The computer system 102 comprises a central processing unit (CPU) 108, a memory 110, and an input/output (I/O) interface 112. The memory 110 may comprise any type of volatile or non-volatile memory, such as, by way of example only, random access memory (RAM), read-only memory (ROM), or a hard drive. Stored within the memory 110 are one or more speech recognition (SR) modules 114.

The network 104 couples together the audio device 106 and the computer system 102 and facilitates the exchange of data between the audio device 106 and the computer system 102. The audio device 106 may comprise a telephone, and the network 104 may comprise the infrastructure of telephone lines and signal switches that route telephone calls. In some embodiments of the invention, the network 104 may be an internet protocol (IP) network, such as the Internet, and the audio device 106 may comprise a voice-over-IP (VoIP) transmitter and receiver.

The I/O interface 112 couples together the network 104 and the computer system 102 and facilitates the exchange of data between the network 104 and the computer system 102. The I/O interface 112 comprises hardware that is capable of establishing a connection with the network 104, such as modems and network adapters. “Utterances” from a user 116 of the audio device 106 may be converted into an analog or digital representation by the audio device 106 and routed through the network 104 to the I/O interface 112. As used herein, an utterance is a vocalization that represents a certain meaning to the system 100. Utterances may be a single word, a few words, a sentence, or even multiple sentences. Once received by the I/O interface 112, the representation may be stored in the memory 110 and processed by the SR module 114 and the CPU 108.

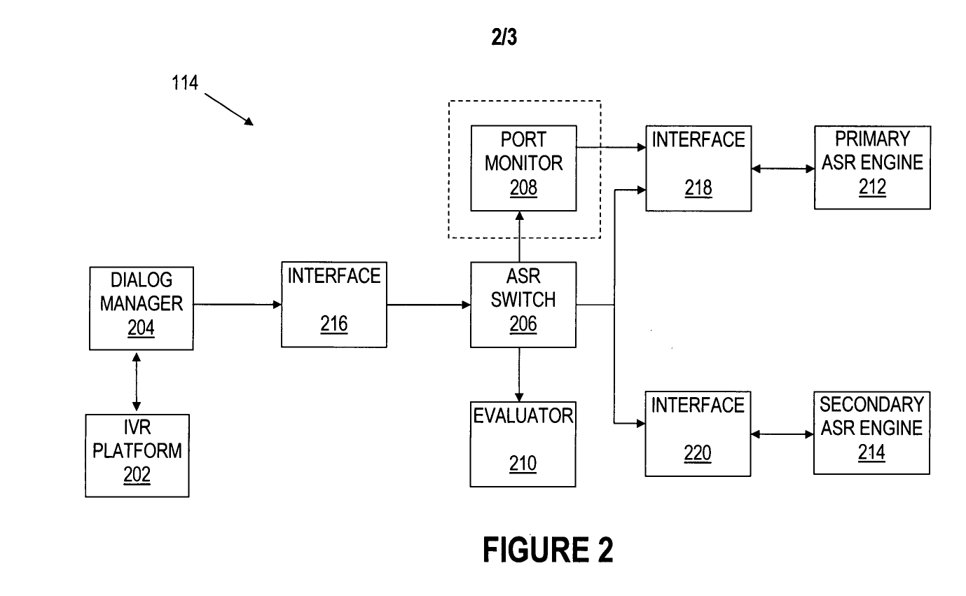

FIG. 2 shows an exemplary implementation of the SR module 114 in greater detail. As shown, the SR module 114 comprises an interactive voice response (IVR) platform 202, a dialog manager 204, an ASR switch 206, a port monitor 208, an evaluator 210, a primary ASR engine 212, and one or more secondary ASR engines 214. One or more interfaces 216, 218, and 220 may facilitate the transfer of data and control signals between components of the SR module 114 via a standard protocol, such as Media Resource Control Protocol (MRCP). The SR module 114 may be implemented via software that is executed by the CPU 108 (FIG. 1) or via a combination of software and hardware. Although the SR module 114 is shown as residing in the single computer system 102 (FIG. 1), the SR module 114 may be distributed to a plurality of distinct computer systems that are coupled together via the network 104 or another connection means.

The IVR platform 202 may comprise a plurality of speech recognition applications that facilitate messaging, portals, and other enhanced voice-enabled interactive services. Typically, the IVR platform 202 is capable of handling a plurality of simultaneous user sessions. Each user session represents an established connection between the IVR platform 202 and the user 116 of the system 100.

To enable ASR functionality, the IVR platform 202 may establish connections with the primary and secondary ASR engines 212 and 214 through the dialog manager 204. The interface 216 negotiates the desired connections with the ASR switch 206. The ASR switch 206 may establish and release connections to the primary ASR engine via the interface 218 and establish and release connections to the secondary ASR engine 214 via the interface 220.

The primary and secondary ASR engines 212 and 214 may comprise logic that performs ASR functions, such as signal processing and matching. The logic embodied in the ASR engines 212 and 214 may be the same or different from each other. If ASR logic is different in the engines 212 and 214, the resulting relative accuracy or performance of the engines may differ. The primary and secondary ASR engines 212 and 214 may be representative of a commercial grade ASR engine and an in-house or open source ASR engine, respectively.

The primary ASR engine 212 is used pursuant to an associated license that specifies the number of simultaneous connections that may be established between the IVR platform 202 and the primary ASR engine 212. The license may carry an associated fee that increases with the larger numbers of licensed connections. For example, a twenty-connection license may cost twice the amount of a ten-connection license. The secondary ASR engine 214 may not have an associated license and thus may establish any number of connections with the IVR platform 202. The secondary ASR engine 214 may be exemplary of an open source ASR engine.

The embodiments of the invention effectively reduce the number of connections established to the primary ASR engine 212 by utilizing the secondary ASR engine 214 whenever a predetermined evaluation condition is met. Since the secondary ASR engine 214 may not have an associated licensing fee, the overall costs associated with ASR functionality in the system 100 may be reduced.

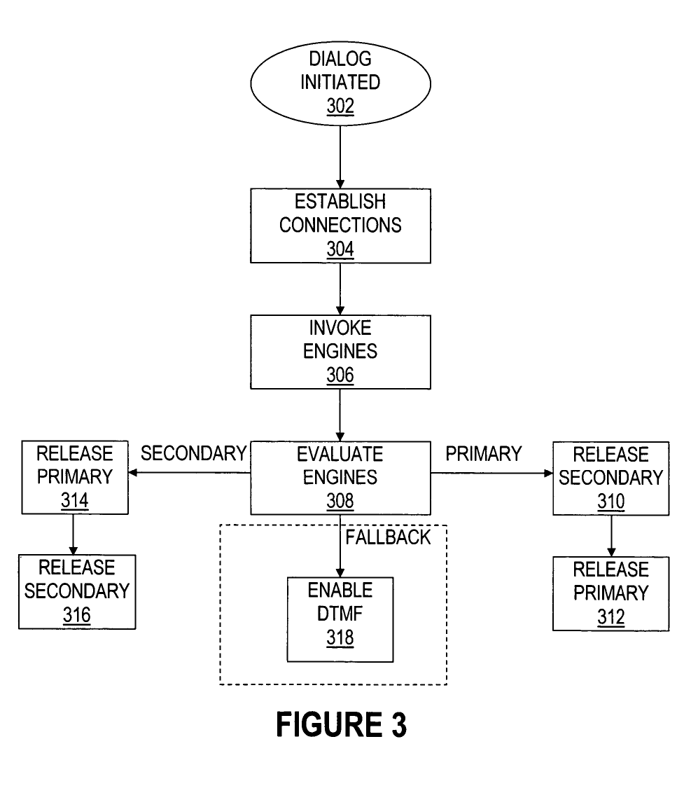

FIG. 3 shows a flow chart of an exemplary ASR connection procedure in accordance with embodiments of the invention should be reviewed with FIG. 2. The dialog manager 204 may initiate the procedure when the user 116 attempts to utilize the ASR system 100 (block 302). In block 304 connections may be established between the IVR platform 202 and both the primary and secondary ASR engines 212 and 214 by the ASR switch 206. Both ASR engines 212 and 214 are invoked (block 306), and an evaluation set of utterances from the user 116 may be evaluated (block 308) by the evaluator 210. The evaluation set of utterances may comprise the first n (e.g., 5) words spoken by the user 116. Based on the evaluation (described below), the primary ASR engine 212 or the secondary ASR engine 214 is selected to process the user's future utterances within the same session. If the primary ASR engine 212 is selected, the connection to the secondary ASR engine 214 is released (block 310). After the user's session completes, the primary ASR engine 212 may be released (block 312). If the secondary ASR engine is selected during the evaluation, the primary ASR engine 212 is released (block 314), and the secondary ASR engine 214 may continue to process the user's utterances. The connection to the secondary ASR engine 214 may be released after the user's session completes (block 316). If neither the primary ASR engine 212 nor the secondary ASR engine 214 pass the evaluation criteria, the ASR switch 206 may be configured to optionally fallback to an alternative communications mechanism, such as Dual Tone Multi-Frequency (DTMF) (block 318). The alternative communications mechanism utilizes a non-ASR input mechanism, such as the touch tone frequencies associated the button the user has pressed. Thus, before validation both the primary and secondary ASR engines 212 and 214 handle the user's session. After validation the user's session is solely handled by the first ASR engine 212, the second ASR engine 214, or optionally by the fallback mechanism 318.

Referring again to FIG. 2, the evaluator 210 may use evaluation criteria to determine whether the primary ASR engine 212, the second ASR engine 214, or optionally the fallback mechanism will handle the user's session after evaluation. The evaluation criteria may be verification-based, response time-based, confidence-based, continuation-based, or a combination thereof. In addition, the number of utterances n used for the evaluation may be decided by a static analysis of the dialog structure associated with the IVR platform 202, a dynamic assessment based on preceding utterances, or a combination thereof.

Verification-based evaluation criteria compare the output of the primary and secondary ASR engines 212 and 214. If the secondary engine 214 produces output identical to the primary ASR engine 212, the secondary ASR engine 214 may be used, thereby allowing other connections to use the licensed ports of the primary ASR engine 212.

Response time-based evaluation criteria determine (e.g., measure), a parameter such as the response time of the primary and secondary ASR engines 212 and 214. If, compared to the primary ASR engine 212, the secondary ASR engine 214 has an identical or shorter response time, the secondary ASR engine 214 may be used after validation.

Confidence-based evaluation criteria use a confidence score generated by the primary and secondary ASR engines 212 and 214 during the evaluation. A threshold may be set that determines when the evaluator 210 should select the secondary ASR engine 214 over the primary ASR engine 212. For example, the threshold may represent a fraction of the confidence score obtained from the primary ASR engine 212. If the confidence score of the secondary ASR engine 214 is equal to or higher than the threshold level, the secondary ASR engine 214 may be utilized.

Continuation-based evaluation criteria determine whether a user has successfully navigated through an ASR menu. For example, if the user is able to reach a menu beyond the first level of a menu system with both ASR engines 212 and 214, the secondary engine 214 may be selected and utilized for the user's future utterances. Successful navigation to a secondary level of the menu system may provide a relative indicator that the secondary ASR engine 214 is detecting and recognizing the user's voice commands.

The ASR switch 206 may use the results of the evaluation, as well as the optional port monitor 208, to determine which connections may be maintained and which connections may be released. In some embodiments, the port monitor 208 may be included and used to monitor currently used ports of the primary ASR engine 212. The port monitor 208, optionally in conjunction with the evaluator 210, determines whether the primary ASR engine 212 should be used without further consideration or whether the exemplary procedure of FIG. 3 should be used to handle a user's session. For example, if the number of available ports exceeds a defined threshold, the primary ASR engine 212 may be used. If the number of available ports falls below the threshold, the procedure of FIG. 3 may be used. The port monitor 208 may provide the number of currently active ports to the evaluator 210 for the evaluator 210 to determine whether the primary engine is to be used or whether the procedure of FIG. 3 is to be used. Alternatively, the port monitor 208 may set a flag, send a message or assert a signal to the evaluator 210 to indicate whether the primary ASR engine 212 is to be used or whether the procedure of FIG. 3 is to be used.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A system, comprising:
a first speech recognition engine;
a second speech recognition engine; and
evaluation logic coupled to the first and second speech recognition engines, the evaluation logic evaluates the first and second speech recognition engines based evaluation signals from a user and, based impart on the evaluation, selects one of said speech recognition engines to process additional speech signals from the user.

2. The system of claim 1 further comprising a switch coupled to the first and second speech recognition engines and the evaluator, wherein, based on the evaluation, the evaluation logic causes the switch to release a connection to the speech recognition engine that was not selected.

3. The system of claim 1 further comprising a communications mechanism and, based on the evaluation, the evaluation logic selects the communications mechanism that is not the first or second speech recognition engines.

4. The system of claim 1 wherein the evaluation logic compares outputs from the first and second speech recognition engines and selects the first speech recognition engine if the outputs are identical.

5. The system of claim 1 wherein the evaluation logic determines a response time for each of the first and second speech recognition engines and selects the second speech recognition engine if the response time of the second speech recognition engine is equal to or shorter than the response time of the first speech recognition engine.

6. The system of claim 1 wherein the evaluation logic receives a first confidence score from the first speech recognition engine and a second confidence score from the second speech recognition engine and selects the second speech recognition engine if the confidence score of the second speech recognition engine is equal to or higher than a threshold.

7. The system of claim 1 wherein the first speech recognition engine permits a plurality of ports to be used on behalf of a plurality of users and the system further comprises a port monitor coupled to the first speech recognition engine and to the evaluation logic, wherein the port monitor determines a number of currently available ports and, if the number of currently available ports exceeds a threshold, causes first speech recognition engine to be used.

8. The system of claim 7 wherein if the number of currently available ports is below a threshold, the port monitor causes one of the speech recognition engines to be selected based on the evaluation.

9. A system, comprising:
first means for recognizing speech;
second means for recognizing speech; and
means for evaluating a parameter associated with the first and second means for recognizing speech based on evaluation voice input from a user during a session and, based on the evaluation, for selecting one of said first and second means for recognizing speech.

10. The system of claim 9 further comprising means for releasing the first or second means for recognizing speech that is not selected .

11. The system of claim 9 wherein the means for evaluating a parameter comprises means for assessing the relative accuracy of the first and second means for recognizing speech.

12. The system of claim 9 wherein the means for evaluating a parameter comprises means for assessing the relative performance of the first and second means for recognizing speech.

13. The system of claim 9 wherein the first and second means for recognizing speech comprise a means for determining a confidence score associated with the voice input.

14. The system of claim 9 further comprising means for monitoring a number of available ports associated with the first means for recognizing speech and for selecting the first means for recognizing speech if the number of available ports exceeds a threshold.

15. A method, comprising:
evaluating an evaluation set of utterances from a user during a session; and
based on evaluating the evaluation set of utterances, selecting between a first speech recognition engine and a second speech recognition engine for the remainder of the session.

16. The method of claim 15 wherein evaluating the evaluation set of utterances comprises determining a relative accuracy of the first and second speech recognition engines.

17. The method of claim 15 wherein evaluating the evaluation set of utterances comprises determining a relative performance of the first and second speech recognition engines.

18. The method of claim 15 wherein evaluating the evaluation set of utterances comprises comparing a first confidence score generated by the first speech recognition engine with a second confidence score generated by the second speech recognition engine.

19. The method of claim 15 further comprising automatically selecting the first speech recognition engine if a number of available ports associated with the first speech recognition engine exceeds a predetermined value.

20. The method of claim 15 further comprising selecting the first or second speech recognition engines based on the evaluation only if a number of available ports associated with the first speech recognition engine falls below a predetermined value.

21. A storage medium containing code that can be loaded into a computer and executed by a processor in the computer, the code causing the computer to:
evaluate an evaluation set of utterances from a user; and
based on the evaluation of the evaluation set of utterances, select between a first speech recognition engine and a second speech recognition engine.

22. The storage medium of claim 21 wherein the code causes the processor to evaluate the evaluation set of utterances by performing an action selected from the group consisting of comparing a relative accuracy of the first and second speech recognition engines, comparing the a relative performance of the first and second speech recognition engines, and comparing a confidence score generated by the first and second speech recognition engines, and a combination thereof.

23. The storage medium of claim 21 wherein the code further causes the processor to determine a number of available ports associated with the first speech recognition engine and to automatically select the first speech recognition engine if the number of available ports is above a threshold.

24. The storage medium of claim 23 wherein the code further causes the processor to select between the first and second speech recognition engines based on the evaluation if the number of available ports is below the threshold.
